(19) United States
(12) Patent Application Publication
(10) Pub. No.: US 2016/0125299 A1
(43) Pub. Date: May 5, 2016

(54) APPARATUS FOR DATA ANALYSIS AND PREDICTION AND METHOD THEREOF

(71) Applicant: SAMSUNG SDS CO., LTD., Seoul (KR)

(72) Inventors: Jae Young LEE, Seoul (KR); Dong Min SHIN, Seoul (KR); Ji Hyeon SEO, Seoul (KR); Da Woon KIM, Seoul (KR)

(73) Assignee: SAMSUNG SDS CO., LTD., Seoul (KR)

(21) Appl. No.: 14/926,499

(22) Filed: Oct. 29, 2015

(30) Foreign Application Priority Data
Oct. 31, 2014 (KR) 10-2014-0149842

(51) Int. Cl. G06N 5/04; G06N 99/00

(52) U.S. Cl. CPC G06N 5/046; G06N 99/005

(57) ABSTRACT

An apparatus and a method for data analysis and prediction, the apparatus including: a data collection unit configured to collect a prediction value derived through a machine learning of input data; a candidate prediction value generation unit configured to generate a candidate prediction value; a rule verification value configured to store one or more rules and verify whether the candidate prediction value violates the one or more rules; and an evaluation unit configured to calculate a fitness of the candidate prediction value according to an error rate of the candidate prediction value with respect to the prediction value and a verification result of the rule verification unit.

### CROSS-REFERENCE TO RELATED APPLICATION

This application claims priority to and the benefit of Korean Patent Application No. 10-2014-0149842, filed on Oct. 31, 2014, the disclosure of which is incorporated herein by reference in its entirety.

### BACKGROUND

1. Field

Embodiments of the present disclosure relate to a hybrid-based analysis and prediction technology that combines a machine learning-based analysis method and a rule-based analysis method.

2. Discussion of Related Art

Machine learning is a subfield of artificial intelligence, and refers to a methodology for deriving new knowledge through learning and analysis of past data. A machine learning model-based analysis has a benefit to derive knowledge or a rule that is hard for humans to represent or acquire, but the derived knowledge is limited to information contained in training data.

Meanwhile, Rule represents a human knowledge in a form being able to processed by a computer (for example, IF-THEN form), being more technical and universal over the machine learning since it can utilize a fact that is not defined by only data, an agreement between transaction subjects, or special knowledge. However, since Rule is dependent of knowledge gained from human experiences, it is very difficult to effectively interpret and represent a complicated relationship between data.

Accordingly, there is a need for technology capable of improving prediction accuracy by effectively combining a machine learning with a rule generated by humans.

### SUMMARY

The present disclosure is directed to a system for analysis and prediction capable of increasing prediction accuracy, with respect to an analysis task analyzing past data (for example, sales data) to expect a future (sales figures), by merging a data analysis result and human knowledge in a hybrid form.

According to an aspect of the present disclosure, there is provided an apparatus for data analysis and prediction, the apparatus including: a data collection unit, a candidate prediction value generation unit, a rule verification value and an evaluation unit. The data collection unit may be configured to collect a prediction value derived through a machine learning of input data. The candidate prediction value generation unit may be configured to generate a candidate prediction value. The rule verification value may be configured to store one or more rules and verify whether the candidate prediction value violates the one or more rules. The evaluation unit may be configured to calculate a fitness of the candidate prediction value according to an error rate of the candidate prediction value with respect to the prediction value and a verification result of the rule verification unit.

The rules may include a penalty value depending on whether the candidate prediction value violates the rules.

The verification result may be a sum of penalty values when the candidate prediction value is applied to each of the one or more rules.

The evaluation unit may determine that the candidate prediction value has a higher fitness as a value obtained by adding the error rate and the sum of the penalty values is smaller.

The candidate prediction value generation unit may change the candidate prediction value according to the fitness, and the evaluation unit recalculates the fitness of the changed candidate prediction value.

The candidate prediction value generation unit may change the candidate prediction value such that a change rate of the prediction value is increased as the fitness of the candidate prediction value is lower.

The candidate prediction value generation unit may repeatedly change the candidate prediction value until the fitness is not increased, and the evaluation unit may select a candidate prediction value having a highest fitness among candidate prediction values generated or changed by the candidate prediction value generation unit as an optimum prediction value.

According to another aspect of the present disclosure, there is provided a method for data analysis and prediction, the method including: collecting a prediction value derived through a machine learning of input data; generating candidate prediction values; calculating an error rate of each of the candidate prediction values with respect to the prediction value; verifying whether the candidate prediction value violates one or more rules; and calculating a fitness of the candidate prediction value according to the error rate and a verification result obtained in the verifying.

The rules may include a penalty value depending on whether the candidate prediction value violates the rules.

The verification result may be a sum of penalty values when the candidate prediction value is applied to each of the one or more rules.

In the calculating of the fitness, the candidate prediction value may be determined to have a higher fitness as a value obtained by adding the error rate and the sum of the penalty values is smaller.

The method may further include, after the calculating of the fitness, changing the candidate prediction value according to the fitness and recalculating the fitness of the changed candidate prediction value.

In the changing of the candidate prediction value, at least some of the candidate prediction values may be changed such that a change rate of the prediction value is increased as the fitness of the candidate prediction value is lower.

The method may further include: repeatedly performing the changing of the candidate prediction value and the recalculating of the fitness until the fitness is not increased; and selecting a candidate prediction value having a highest fitness among generated or changed candidate prediction values as an optimum prediction value.

According to another aspect of the present disclosure, there is provided a computer program stored in a recording medium to execute operations in combination with hardware, the operations including: collecting a prediction value derived through a machine learning of input data; generating a candidate prediction value; calculating an error rate of the candidate prediction value with respect to the prediction value; verifying whether the candidate prediction value violates one or more rules; and calculating a fitness of the candidate prediction value according to the error rate and a verification result obtained in the verifying.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram illustrating an apparatus for data analysis and prediction according to an exemplary embodiment of the present disclosure; and

FIG. 2 is a flowchart showing a method for data analysis and prediction according to an exemplary embodiment of the present disclosure.

### DETAILED DESCRIPTION OF EXEMPLARY EMBODIMENTS

Exemplary embodiments of the present disclosure will be described in detail below with reference to the accompanying drawings. The following description is intended to provide a general understanding of the method, apparatus and/or system described in the specification, but it is illustrative purpose only and should not be construed as limiting the present disclosure.

In describing the present disclosure, detailed descriptions that are well-known but are likely to make the subject matter of the present disclosure unclear will be omitted in order to avoid redundancy. The terminology used herein is defined in consideration of its function in the present disclosure, and may vary with an intention of a user and an operator or custom. Accordingly, the definition of the terms should be determined based on overall contents of the specification. The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

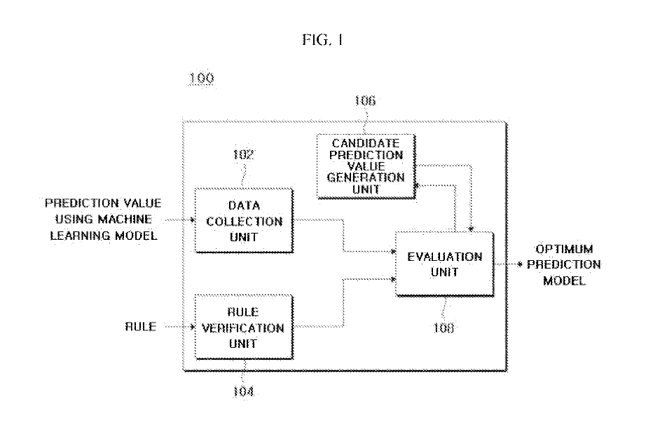

FIG. 1 is a block diagram illustrating an apparatus for data analysis and prediction 100 according to an exemplary embodiment of the present disclosure. The apparatus for data analysis and prediction 100 according to an exemplary embodiment of the present disclosure is an apparatus for analyzing past data, for example, data about selling a certain product in the past, to generate a prediction value of future, for example, expected sales figures of the product in the future, the apparatus for merging an analysis result according to data and human knowledge in a hybrid form so that the prediction accuracy is increased. Referring to FIG. 1, the apparatus for data analysis and prediction 100 according to an exemplary embodiment of the present disclosure includes a data collection unit (or a data collector) 102, a rule verification unit (or a rule verifier) 104, a candidate prediction value generation unit (or a candidate prediction value generator) 106 and an evaluation unit (or an evaluator) 108.

The above modules of the apparatus 100 may be implemented with hardware. For example, the apparatus 100 may be implemented or included in a computing apparatus. The computing apparatus may include at least one processor and a computer-readable storage medium such as a memory that is accessible by the processor. The computer-readable storage medium may be disposed inside or outside the processor, and may be connected with the processor using well known means. A computer executable instruction for controlling the computing apparatus may be stored in the computer-readable storage medium. The processor may execute an instruction stored in the computer-readable storage medium. When the instruction is executed by the processor, the instruction may allow the processor to perform an operation according to an example embodiment. In addition, the computing apparatus may further include an interface device configured to support input/output and/or communication between the computing apparatus and at least one external device, and may be connected with an external device (for example, a device in which a system that provides a service or solution and records log data regarding a system connection is implemented). Furthermore, the computing apparatus may further include various different components (for example, an input device and/or an output device), and the interface device may provide an interface for the components. Examples of the input device include a pointing device such as a mouse, a keyboard, a touch sensing input device, and a voice input device, such as a microphone. Examples of the output device include a display device, a printer, a speaker, and/or a network card. Thus, the data collection unit 102, the rule verification unit 104, the candidate prediction value generation unit 106 and the evaluation unit 108 of the apparatus for data analysis and prediction 100 may be implemented as hardware of the above-described computing apparatus.

The data collection unit 102 collects prediction values by a machine learning model derived as a result of machine learning with respect to input data. According to exemplary embodiments of the present disclosure, the input data represents data of past instances that are subject of machine learning, for example, sales data of the past. In addition, the machine learning represents a computer-based analysis method for deriving new knowledge from input data through learning or analysis of the input data. For example, there are various algorithms for the machine learning, including Decision Tree, Neural Network, and Support Vector Machine.

According to an exemplary embodiment of the present disclosure, the data collection unit 102 may be configured to be connected to a separate machine learning apparatus via a network. In this case, the data collection unit 102 may receive a predication result according to a machine learning model derived from performing a machine learning in the machine learning apparatus through the network. According to another exemplary embodiment of the present disclosure, the data collection unit 102 may be configured to include machine learning modules at an inside thereof. In this case, the data collection unit 102 may directly derive a machine learning model and a prediction model according to the machine learning model from input data.

The rule verification unit 104 stores and manages one or more rules. The rules represent a human knowledge in a form that is able to be processed by a computer, and the rules are represented as a logic operation (GREATER, EQUAL, AND, OR, NOT) with respect to a certain fact. According to an exemplary embodiment of the present disclosure, the rules may be represented as a conditional statement of IF-THEN. An “If” clause may contain a condition, and a “THEN” clause may contain a penalty associated with a violation of the condition. An example of the rules is as follows. The following rules show if a value of ITEM is AS10, a value of SHIP_TO is T SKY, a value of DAY is Wednesday/Saturday/Sunday, and QTY is larger than 0, penalty is infinity, or else penalty is 0.

```
  IF (ITEM=‘AS10’ AND SHIP_TO=‘T SKY’ AND DAY = (WED OR SAT
OR SUN) AND QTY>0)
  THEN Penalty = ∞, ELSE Penalty = 0
```

The rule verification unit 104, if a query on whether a certain prediction value violates a rule is received from the evaluation unit 108, which will be described later, verifies whether the requested prediction value violates a rule. In detail, the rule verification unit 104 applies the certain prediction value to one or more rules that are stored in the rule verification unit 104, and returns a sum of penalty values according to a result of the application to the evaluation unit 108.

The candidate prediction value generation unit 106 generates a candidate prediction value and provides the generated candidate prediction value to the evaluation unit 108. In addition, the candidate prediction value generation unit 106 changes the candidate prediction value according to a fitness calculated by the evaluation unit 108, and provides the changed candidate prediction value to the evaluation unit 108. Searching for the optimum prediction value through a change of the candidate prediction value will be described later in detail.

The evaluation unit 108 calculates a fitness of the candidate predication value provided from the candidate prediction value generation unit 106, and derives an optimum prediction value from the calculation result. In detail, the evaluation unit 108 is configured to calculate a fitness of the candidate prediction value according to an error rate of the candidate prediction value with respect to the prediction value of the machine learning model provided from the data collection unit 102 and the verification result of the rule verification unit 104.

According to an exemplary embodiment of the present disclosure, a fitness of a certain candidate prediction value may be represented as an objective function in a form where an error rate of the candidate prediction value with respect to the prediction value of the machine learning model and a violation rate (a sum of penalty values) against a rule. In this case, the evaluation unit 108 may determine that the candidate prediction value has a high fitness as a value of the objective function is smaller.

For example, when it is assumed that a set of input values of a machine learning model is X={X₀, X₁, . . . , Xₙ}, a set of prediction values of the machine learning model is O={O₀, O₁, . . . , Oₙ}, and a set of candidate prediction values generated by the candidate prediction value generation unit 106 is t={t₀, t₁, . . . , tₙ}, an error rate of the candidate prediction value with respect to the prediction value of the machine learning model _{MachineLearning} is expressed as Equation 1 shown below.

$${Error}_{Machine Learning} ( O , t ) = {\sum }_{i = 0}^{n} {( {O}_{i} - {t}_{i} )}^{2} \qquad [ Equation 1 ]$$

That is, the error rate is calculated as a Euclidian distance between the prediction value derived from the machine learning model and the candidate prediction value. However, exemplary embodiments of the present disclosure are not limited thereto. For example, the evaluation unit 108 may calculate the error rate by applying another type of calculation algorithm.

In addition, a penalty Penaltyᵣᵤₗₑ imposed when a certain candidate value violates a rule may be expressed as Equation 2 below.

$${Penalty}_{rule} ( t ) = {\sum }_{i = 0}^{n} {Rule}_{matched} ( {t}_{i} ) \qquad [ Equation 2 ]$$

In Equation 2, Rule_{matched}(tᵢ) is a function for returning a penalty value when tᵢ is applied to each of one or more rules stored in the rule verification unit 104.

An objective function Obj is provided in a form where Equation 1 is combined with Equation 2, shown as Equation 3 below.

$$\begin{matrix}Obj ( O , t ) = {Error}_{Machine Learning} ( O , t ) + {Penalty}_{rule} ( t ) \\ = {\sum }_{i = 0}^{n} {( {O}_{i} - {t}_{i} )}^{2} + {\sum }_{i = 0}^{n} {Rule}_{matched} ( {t}_{i} )\end{matrix} \qquad [ Equation 3 ]$$

The evaluation unit 108 selects a candidate prediction value minimizing a value of the objective function, that is, a candidate prediction value having a highest fitness as an optimum prediction value. In this case, the searching of the optimum prediction value may be performed by a random search-based searching algorithm, for example, stochastic optimization, such as a genetic algorithm.

For example, the candidate prediction value generation unit 106 may receive a fitness corresponding to a case, in which the generated candidate prediction value is applied to the objective function, from the evaluation unit 108, and according to the fitness, change the prediction value included in the candidate prediction value. In this case, the candidate prediction value generation unit 106 may increase a change rate of the prediction value if the fitness is low (that is, if the value of the target function is large) to generate a candidate prediction value in a different form, and may decrease a change rate of the prediction value if the fitness is high (that is, if the value of the target function is small) to generate a candidate prediction value similar to a previous candidate prediction value. Then, the evaluation unit 108 recalculates the fitness of the candidate prediction value changed by the candidate prediction value generation unit 106, and provides the candidate prediction value generation unit 106 with the recalculated fitness.

The above processes are repeated until the fitness is not increased any more, or until the fitness reaches a predetermined value, and the evaluation unit 108 may select a candidate prediction value having a highest fitness (that is, a candidate prediction value causing the objective function to produce a smallest value) among candidate prediction values generated or changed by the candidate prediction value generation unit 106 as an optimum prediction value.

According to the exemplary embodiment of the present disclosure, a prediction result of a machine learning is combined with a result based on expert knowledge, thereby improving the prediction accuracy. In addition, the rule may be continuously modified and complimented, thereby flexibility coping with an external environmental change.

Hereinafter, the following description will be made in relation on a process of searching for an optimum prediction value in the apparatus for data analysis and prediction 100.

For example, it may be assumed that sales prediction of 39^{th} week according to a machine learning model derived from past sales data of article A (sales records in the past 1 to 35^{th} weeks) and an actual sales volume are represented as Table 1 and table 2, respectively, as shown below.

TABLE 1

| Week | Mon. | Tue. | Wed. | Thurs. | Fri. | Sat. | Sun. |
|---|---|---|---|---|---|---|---|
| 38^{th} | 0 | 0 | 0 | 23 | 0 | 0 | 0 |

TABLE 2

| Week | Mon. | Tue. | Wed. | Thurs. | Fri. | Sat. | Sun. |
|---|---|---|---|---|---|---|---|
| 38^{th} | 0 | 0 | 0 | 0 | 70 | 0 | 0 |

As shown in the Tables 1 and 2, a result of the machine learning has a great error compared to the actual sales figures. That is, according to the machine learning prediction, 23 orders are expected on Thursday, but in practice, 70 orders are placed on Friday.

Table 3 is a prediction of sales volume when the following rule is applied to the result of machine learning. The following rule is a representation in an IF-THEN form indicating “simultaneously ordering all of the amount of sales forecast (Return To Forecast (RTF), that is, 70 orders for the 38^{th} week) on Friday.

IF NOT ((WEEKDAY == FRI) AND (QTY == RTF))
THEN Penalty = ∞
ELSE Penalty = 0

TABLE 3

| Week | Mon. | Tue. | Wed. | Thurs. | Fri. | Sat. | Sun. |
|---|---|---|---|---|---|---|---|
| 38^{th} | 0 | 0 | 1 | 0 | 69 | 0 | 0 |

Comparing Table 1 with Table 3, when the rule is applied together with the machine learning similarity between the prediction value and an actual result is increased compared to when only the machine learning is applied.

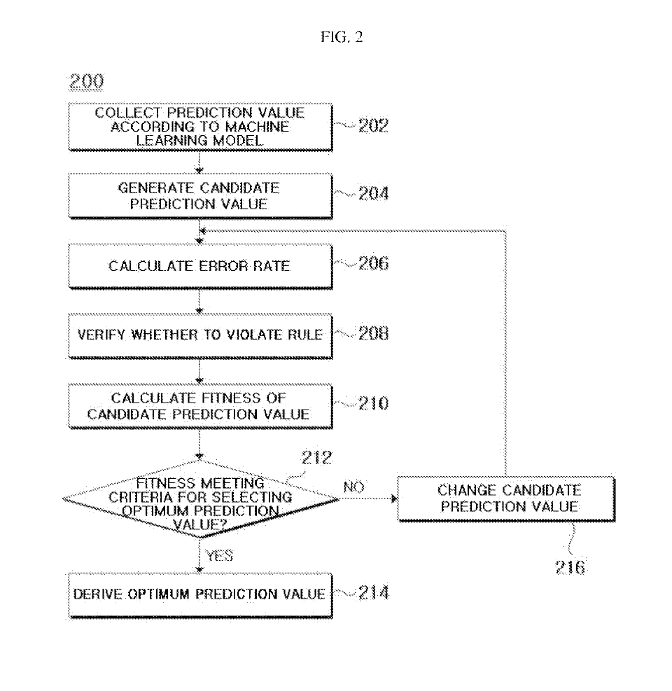

FIG. 2 is a flowchart showing a method for data analysis and prediction 200 according to an exemplary embodiment of the present disclosure. The method for data analysis and prediction (200) according to an exemplary embodiment of the present disclosure may be performed by the apparatus for data analysis and prediction 100 describe above.

In operation 202, the data collection unit 102 collects a prediction value according to a machine learning model derived from performing a machine learning on input data.

In operation 204, the candidate prediction value generation unit 106 generates a candidate prediction value.

In operation 206, the evaluation unit 108 calculates an error rate of the candidate prediction value with respect to the machine learning model.

In operation 208, the rule verification unit 104 verifies whether the candidate prediction value violates one or more rules.

In operation 210, the evaluation unit 108 calculates a fitness of the candidate prediction value according to the error rate and the verification result obtained in the rule verification unit 104.

In operation 212, the evaluation unit 108 determines whether the fitness meets a predetermined criterion for selecting an optimum prediction value. In detail, the evaluation unit 108 may compare the fitness with a previously calculated fitness, and if the fitness is increased any more or reaches a predetermined reference value for fitness, determines that the fitness meets the predetermined criteria for selecting an optimum prediction value.

In operation 214, if it is determined in operation 212 that the fitness meets the predetermined criteria for selecting an optimum prediction value, the evaluation unit 108 selects a candidate prediction value having a highest fitness (that is, a candidate prediction value causing the objective function to have a smallest value) among candidate prediction values as an optimum prediction value.

In operation 216, if it is determined in operation 212 that the fitness does not meet the predetermined criterion for selecting an optimum prediction value, the candidate prediction value generation unit 106 changes the candidate prediction value and performs sequential operations starting from operation 206 on the changed candidate prediction value.

Meanwhile, the embodiments of the present disclosure may include a computer readable recording medium including a program to perform the methods described in the specification on a computer. The computer readable recording medium may include a program instruction, a local data file a local data structure or in the combination of one or more of these. The medium may be designed and constructed for the present disclosure, or generally used in the computer software field. Examples of the computer readable recording medium include hardware device constructed to store and execute a program instruction, for example, a magnetic media such as hard disks, floppy disks, and magnetic tapes, optical media such as CD-ROMs, and DVDs, magneto-optical media such as floptical disk, read-only memories (ROM), random access memories (RAM), and flash memories. In addition, the program instruction may include a machine code made by a compiler, and a high-level language executable by a computer through an interpreter.

As is apparent from the above, a prediction value of an object to be analyzed is generated by combining a machine learning-based analysis method with a rule-based analysis method, thereby improving the prediction accuracy.

It will be apparent to those skilled in the art that various modifications can be made to the above-described exemplary embodiments of the present disclosure without departing from the spirit or scope of the disclosure. Thus, it is intended that the present disclosure covers all such modifications provided they come within the scope of the appended claims and their equivalents.

What is claimed is:

1. An apparatus for data analysis and prediction, the apparatus comprising:
a data collection unit configured to collect a prediction value derived through a machine learning of input data;
a candidate prediction value generation unit configured to generate a candidate prediction value;
a rule verification value configured to store one or more rules and verify whether the candidate prediction value violates the one or more rules; and
an evaluation unit configured to calculate a fitness of the candidate prediction value according to an error rate of the candidate prediction value with respect to the prediction value and a verification result of the rule verification unit.

2. The apparatus of claim 1, wherein the rules include a penalty value depending on whether the candidate prediction value violates the rules.

3. The apparatus of claim 2, wherein the verification result is a sum of penalty values when the candidate prediction value is applied to each of the one or more rules.

4. The apparatus of claim 3, wherein the evaluation unit determines that the candidate prediction value has a higher fitness as a value obtained by adding the error rate and the sum of the penalty values is smaller.

5. The apparatus of claim 1, wherein the candidate prediction value generation unit changes the candidate prediction value according to the fitness, and
the evaluation unit recalculates the fitness of the changed candidate prediction value.

6. The apparatus of claim 5, wherein the candidate prediction value generation unit changes the candidate prediction value such that a change rate of the prediction value is increased as the fitness of the candidate prediction value is lower.

7. The apparatus of claim 5, wherein the candidate prediction value generation unit repeatedly changes the candidate prediction value until the fitness is not increased, and
the evaluation unit selects a candidate prediction value having a highest fitness among candidate prediction values generated or changed by the candidate prediction value generation unit as an optimum prediction value.

8. A method for data analysis and prediction, the method comprising:
collecting a prediction value derived through a machine learning of input data;
generating candidate prediction values;
calculating an error rate of each of the candidate prediction values with respect to the prediction value;
verifying whether the candidate prediction value violates one or more rules; and
calculating a fitness of the candidate prediction value according to the error rate and a verification result obtained in the verifying.

9. The method of claim 8, wherein the rules includes a penalty value depending on whether the candidate prediction value violates the rules.

10. The method of claim 9, wherein the verification result is a sum of penalty values when the candidate prediction value is applied to each of the one or more rules.

11. The method of claim 10, wherein, in the calculating of the fitness, the candidate prediction value is determined to have a higher fitness as a value obtained by adding the error rate and the sum of the penalty values is smaller.

12. The method of claim 8, further comprising, after the calculating of the fitness, changing the candidate prediction value according to the fitness and recalculating the fitness of the changed candidate prediction value.

13. The method of claim 12, wherein, in the changing of the candidate prediction value, at least some of the candidate prediction values are changed such that a change rate of the prediction value is increased as the fitness of the candidate prediction value is lower.

14. The method of claim 12, further comprising:
repeatedly performing the changing of the candidate prediction value and the recalculating of the fitness until the fitness is not increased; and
selecting a candidate prediction value having a highest fitness among generated or changed candidate prediction values as an optimum prediction value.

15. A computer program stored in a recording medium to execute operations in combination with hardware, the operations comprising:
collecting a prediction value derived through a machine learning of input data;
generating a candidate prediction value;
calculating an error rate of the candidate prediction value with respect to the prediction value;
verifying whether the candidate prediction value violates one or more rules; and
calculating a fitness of the candidate prediction value according to the error rate and a verification result obtained in the verifying.
